(19) United States
(12) Patent Application Publication
(10) Pub. No.: US 2026/0311001 A1
(43) Pub. Date: Oct. 8, 2026

(54) INFORMATION PROCESSING APAPRATUS AND INFORMATION PROCESSING METHOD

(71) Applicant: NEC Corporation, Tokyo (JP)

(72) Inventors: Akinori EBIHARA, Tokyo (JP); Taiki MIYAGAWA, Tokyo (JP)

(73) Assignee: NEC Corporation, Tokyo (JP)

(21) Appl. No.: 19/481,900

(22) PCT Filed: May 19, 2023
(86) PCT No.: PCT/JP2023/018784

§ 371 Date: Nov. 6, 2025

(51) Int. Cl. G06N 5/04; G06F 18/24

(52) U.S. Cl. CPC G06N 5/04; G06F 18/24

(57) ABSTRACT

An information processing apparatus includes: an estimation unit that estimates second series data corresponding to first series data by inputting the first series data; an acquisition unit that acquires a pair of the first series data and the second series data; a quantization unit that quantizes a second element included in the second series data; an encoding unit that encodes the quantized second element; and a learning unit that assigns a value of each digit of the encoded second element to respective one of a plurality of classification units provided in the estimation unit, and that causes learning by each of the plurality of classification units by using a first element included in the first series data and the assigned second element. According to such an information processing apparatus, it is possible to appropriately estimate real values from series data.

### TECHNICAL FIELD

The present disclosure relates to technical fields of an information processing apparatus, an information processing method, and a recording medium.

### Background Art

A known apparatus of this type performs class classification of series data by using a likelihood ratio. For example, Patent Literature 1 discloses that series data are classified to one of a predetermined plurality of classes by sequentially acquiring and analyzing a plurality of elements included in the series data.

### CITATION LIST

### Patent Literature

[Patent Literature 1] International Publication No. WO2020/194497

### SUMMARY

### Technical Problem

The present disclosure aims to improve the aforementioned related techniques/technologies.

### Solution to Problem

An information processing apparatus according to an example aspect of the present disclosure includes: an estimation unit that estimates second series data corresponding to first series data by inputting the first series data; an acquisition unit that acquires a pair of the first series data and the second series data; a quantization unit that quantizes a second element included in the second series data; an encoding unit that encodes the quantized second element; and a learning unit that assigns a value of each digit of the encoded second element to respective one of a plurality of classification units provided in the estimation unit, and that causes learning by each of the plurality of classification units by using a first element included in the first series data and the assigned second element.

An information processing apparatus according to another example aspect of the present disclosure includes: a data acquisition unit that acquires first series data; a plurality of classification units that estimate, by inputting a plurality of first elements included in the first series data, values of each digit of encoded second elements corresponding to the first elements; and a decoding unit that decodes the values of each digit of the second elements estimated by respective one of the plurality of classification units, thereby obtaining second series data corresponding to the first series data.

An information processing method according to an example aspect of the present disclosure is an information processing method that causes learning by an estimation unit that estimates second series data corresponding to first series data by inputting the first series data, the information processing method including: acquiring a pair of the first series data and the second series data; quantizing a second element included in the second series data; encoding the quantized second element; and assigning a value of each digit of the encoded second element to respective one of a plurality of classification units provided in the estimation unit, and causing learning by each of the plurality of classification units by using a first element included in the first series data and the assigned second element.

An information processing method according to another example aspect of the present disclosure includes: acquiring first series data; estimating, by inputting a plurality of first elements included in the first series data, values of each digit of encoded second elements corresponding to the first elements; and decoding the values of each digit of the second elements estimated, thereby obtaining second series data corresponding to the first series data.

A recording medium according to an example aspect of the present disclosure is a recording medium on which a computer program that allows a computer to execute an information processing method is recorded, the information processing method causing learning by an estimation unit that estimates second series data corresponding to first series data by inputting the first series data, the information processing method including: acquiring a pair of the first series data and the second series data; quantizing a second element included in the second series data; encoding the quantized second element; and assigning a value of each digit of the encoded second element to respective one of a plurality of classification units provided in the estimation unit, and causing learning by each of the plurality of classification units by using a first element included in the first series data and the assigned second element.

A recording medium according to another example aspect of the present disclosure is a recording medium on which a computer program that allows a computer to execute an information processing method is recorded, the information processing method including: acquiring first series data; estimating, by inputting a plurality of first elements included in the first series data, values of each digit of encoded second elements corresponding to the first elements; and decoding the values of each digit of the second elements estimated, thereby obtaining second series data corresponding to the first series data.

### BRIEF DESCRIPTION OF DRAWINGS

FIG. 1 is a block diagram illustrating a hardware configuration of a first information processing apparatus.

FIG. 2 is a block diagram illustrating a functional configuration of the first information processing apparatus.

FIG. 3 is a graph illustrating a processing example of quantization and encoding in the first information processing apparatus.

FIG. 4 is a graph illustrating an example of estimated values estimated by the first information processing apparatus.

FIG. 5 is a graph illustrating a method of classifying the estimated values in the first information processing apparatus.

FIG. 6 is a flowchart illustrating a flow of operation of the first information processing apparatus.

FIG. 7 is a block diagram illustrating a functional configuration of a second information processing apparatus.

FIG. 8 is a flowchart illustrating a flow of operation of the second information processing apparatus.

### DESCRIPTION OF EXAMPLE EMBODIMENTS

Hereinafter, an information processing apparatus, an information processing method, and a recording medium according to example embodiments will be described with reference to the drawings.

### First Example Embodiment

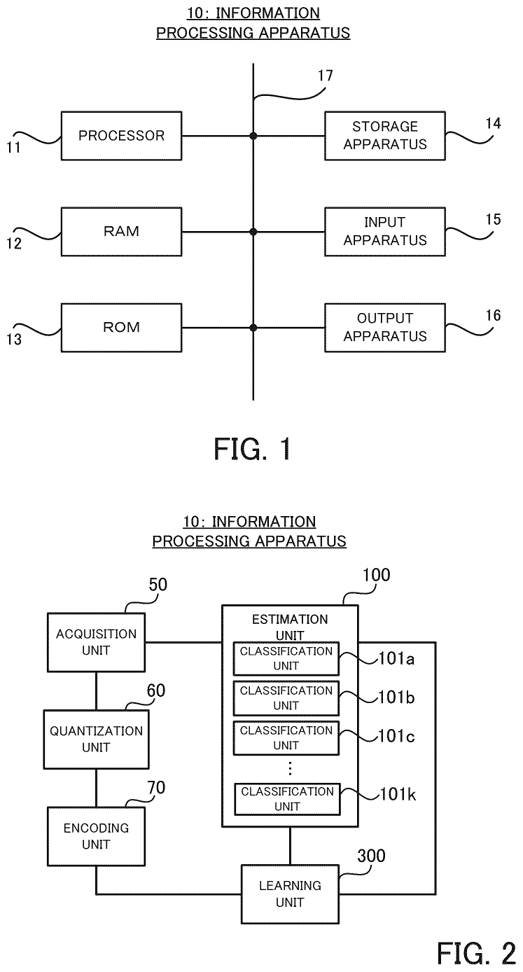

A first example embodiment will be described with reference to FIG. 1 to FIG. 6.

### Hardware Configuration

First, with reference to FIG. 1, a hardware configuration of a first information processing apparatus will be described. FIG. 1 is a block diagram illustrating the hardware configuration of the first information processing apparatus.

As illustrated in FIG. 1, a first information processing apparatus 10 includes a processor 11, a RAM (Random Access Memory) 12, a ROM (Read-Only Memory) 13, and a storage apparatus 14. The information processing apparatus 10 may further include an input apparatus 15 and an output apparatus 16. The processor 11, the RAM 12, the ROM 13, the storage apparatus 14, the input apparatus 15, and the output apparatus 16 are connected via a data bus 17.

The processor 11 reads a computer program. For example, the processor 11 is configured to read a computer program stored in at least one of the RAM 12, the ROM 13, and the storage apparatus 14. Alternatively, the processor 11 may read a computer program stored on a computer-readable recording medium, by using a not-illustrated recording medium reading apparatus. The processor 11 may also acquire (i.e., read) a computer program from a not-illustrated apparatus disposed outside the information processing apparatus 10 via a network interface. The processor 11 controls the RAM 12, the storage apparatus 14, the input apparatus 15, and the output apparatus 16 by executing the read computer program. Especially in the present example embodiment, when the processor 11 executes the read computer program, a function block for performing various types of processing related to a likelihood ratio is realized in the processor 11. That is, the processor 11 may function as a controller that performs each control in the information processing apparatus 10.

The processor 11 may be configured, for example, as a CPU (Central Processing Unit), a GPU (Graphics Processing Unit), a FPGA (field-programmable gate array), a DSP (Digital Signal Processor), an ASIC (Application Specific Integrated Circuit), or a quantum processor. The processor 11 may be configured by using one of them, or a plurality of them in parallel.

The RAM 12 temporarily stores the computer program to be executed by processor 11. The RAM 12 temporarily stores data that are temporarily used by the processor 11 when the processor 11 is executing the computer program. The RAM 12 may be, for example, a D-RAM (Dynamic Random Access Memory) or a SRAM (Static Random Access Memory). In addition, another type of volatile memory may be used in place of the RAM 12.

The ROM 13 stores the computer program to be executed by the processor 11. The ROM 13 may also store other fixed data. The ROM 13 may be, for example, a P-ROM (Programmable Read Only Memory) or an EPROM (Erasable Read Only Memory). In addition, another type of nonvolatile memory may be used in place of the ROM 13.

The storage apparatus 14 stores data that are stored by the information processing apparatus 10 for a long time. The storage apparatus 14 may operate as a transitory storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing apparatus 10. The input apparatus 15 may include, for example, at least one of a keyboard, a mouse, and a touch panel. The input apparatus 15 may be configured as a portable terminal such as a smartphone and a tablet. The input apparatus 15 may be an apparatus that allows audio input/voice input, including a microphone, for example.

The output apparatus 16 is an apparatus that outputs information about the information processing apparatus 10 to the outside. For example, the output apparatus 16 may be a display apparatus (e.g., a display) that is configured to display the information about the information processing apparatus 10. The output apparatus 16 may be a speaker or the like that is configured to audio-output the information about the information processing apparatus 10. The output apparatus 16 may be configured as a portable terminal such as a smartphone and a tablet.

Although FIG. 1 illustrates an example of the information processing apparatus 10 including a plurality of apparatuses, all or a part of functions thereof may be realized by a single apparatus. Such an information processing apparatus may include, for example, only the processor 11, the RAM 12, and the ROM 13 described above. The other components (i.e., the storage apparatus 14, the input apparatus 15, the output apparatus 16, etc.) may be provided in an external apparatus connected to the information processing apparatus 10. In addition, the information processing apparatus 10 may realize a part of an arithmetic function by using an external apparatus (e.g., an external server or cloud, etc.).

### Functional Configuration

Next, with reference to FIG. 2, a functional configuration of the first information processing apparatus 10 will be described. FIG. 2 is a block diagram illustrating the functional configuration of the first information processing apparatus.

As illustrated in FIG. 2, the first information processing apparatus 10 includes, as components for realizing its functions, an acquisition unit 50, a quantization unit 60, an encoding unit 70, an estimation unit 100, and a learning unit 300. Each of the acquisition unit 50, the quantization unit 60, the encoding unit 70, the estimation unit 100, and the learning unit 300 may be a processing block realized, for example, by the aforementioned processor 11 (see FIG. 1).

The acquisition unit 50 is configured to acquire series data. The series data here refers to data including a plurality of elements arranged in a predetermined order, and an example of the series data may be time-series data. More specific examples of the series data include, but are not limited to, subdivided video data, audio data, or image data. The acquisition unit 50 may acquire data directly from an arbitrary data acquisition apparatus (e.g., a camera or a microphone, etc.), or may read data that are previously acquired by a data acquisition apparatus and stored in a storage or the like. In a case of acquiring data from a camera, the acquisition unit 50 may be configured to acquire the data from each of a plurality of cameras.

The acquisition unit 50 in the first information processing apparatus 10 is especially configured to acquire a pair of first series data and second series data corresponding to the first series data. The second series data are data including a second element that is a real value, and indicates a value corresponding to an estimated value obtained by inputting a first element included in the first series data to the estimation unit 100. That is, the second series data are acquired as correct answer data in learning by the estimation unit 100. The combination of the first series data and the second series data are not particularly limited, as long as there is a correspondence between the two. For example, in a case where the first series data indicate images of a pedestrian, the second series data may indicate the pedestrian's facial orientations. Alternatively, in a case where the first series data indicate satellite images, the second series data may indicate precipitation amounts at corresponding times. The pair of the first series data and the second series data may be generated by a prior annotation work.

The quantization unit 60 is configured to quantize the second element included in the second series data, from among the series data acquired by the acquisition unit 50. That is, the quantization unit 60 may be configured to perform processing of cancelling significant digits of the second element that is a real value. A more specific operation of the quantization unit 60 will be described in detail later.

The encoding unit 70 is configured to encode the second element that is quantized by the quantization unit 60. The encoding unit 70 may be configured to perform processing of encoding the second element, based on pre-set rules. A more specific operation of the encoding unit 70 will be described in detail later.

The estimation unit 100 is configured to estimate the second series data from the first series data acquired by the acquisition unit 50. More specifically, the estimation unit 100 is configured to estimate a plurality of second elements included in the second series data from a plurality of first elements included in the first series data. The estimation unit 100 according to the present example embodiment example embodiment estimates the second elements by using a plurality of classification units 101a to 101k. The number (k) of the classification units 101 corresponds to the number of digits of the second elements to be estimated. Specifically, each classification unit 101 estimates a value corresponding to respective one of digits of the second elements. For example, the classification unit 101a estimates the value of a first digit, the classification unit 101b estimates the value of a second digit, . . . , and the classification unit 101k estimates the value of a k-th digit. The number of digits k corresponds to the number of digits of the second elements encoded by the encoding unit 70.

Each of the plurality of classification units 101 may estimate the value of respective one digit by using a likelihood ratio. Each classification unit 101 selects at least one class to which each piece of data belongs, from among a plurality of candidate classes. For example, each classification unit 101 may perform binary classification of “1” or “0” by using a likelihood ratio. Here, the “likelihood ratio” is an index indicating the likelihood of the class to which each piece of data belongs. Each classification unit 101 may be configured to calculate the likelihood ratio, based on a relation between at least two consecutive elements among the plurality of first elements included in the first series data. A specific classification method using the likelihood ratio will be described in detail later.

The learning unit 300 is configured to cause learning by or train each of the plurality of classification units 101 provided in the estimation unit 100. Specifically, the learning unit 300 causes learning by each of the plurality of classification units 101, by using the first elements included in the first series data, and the second element(s), which is the correct answer data for that first element(s). The second element(s) used as the correct answer data is the second element(s) that is quantized by the quantization unit 60 and is encoded by the encoding unit 70. The quantized and encoded second element(s) is assigned to the corresponding classification unit 101. For example, the classification unit 101a may learn by using the value of the first digit of the encoded second element(s). Similarly, the classification unit 101k may learn by using the value of the k-th digit of the encoded second element(s). A learning method is not particularly limited, but the learning unit 300 may cause learning by the classification units 101, for example, by using backpropagation. Since existing techniques/technologies (e.g., see References 1 and 2 below) may be applicable to the learning method as appropriate, a detailed description of the learning method is omitted here.
[Reference 1]: International Publication No. WO 2021/229663
[Reference 2]: International Publication No. WO 2022/157973

### Quantization and Encoding

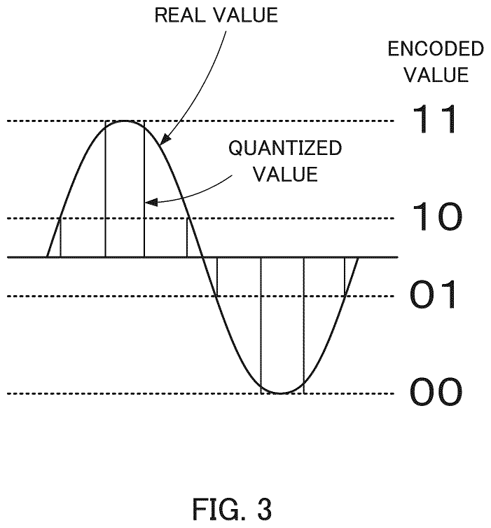

Next, with reference to FIG. 3, the operation of the quantization unit 60 and the encoding unit 70 described above will be described. FIG. 3 is a graph illustrating a processing example of the quantization and the encoding in the first information processing apparatus.

As illustrated in FIG. 3, the second elements (i.e., the elements included in the second series data) that are real values acquired by the acquisition unit 50, are first quantized by the quantization unit 60. The quantized values are discrete values, as illustrated in the figure.

Subsequently, the quantized values are encoded by the encoding unit 70. Illustrated here is an example of binary encoding (encoding using 0/1 codes), but other methods may also be used for encoding. In a case of encoding into binary values, such as in binary encoding, each classification unit 101 may be configured to perform binary classification. Furthermore, if the values are encoded to take three or more values, each classification unit 101 may be configured to perform multi-class classification including three or more classes.

### Estimation of Real Value

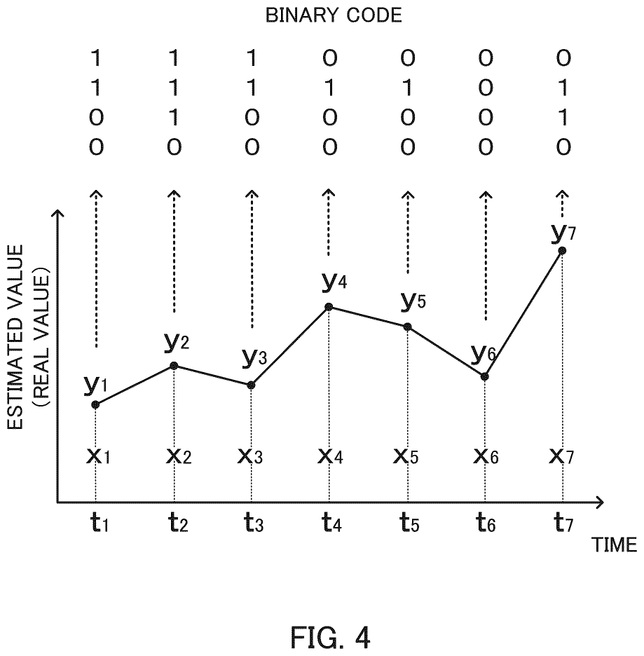

Next, with reference to FIG. 4, an estimation operation by the estimation unit 100 will be described in detail. FIG. 4 is a graph illustrating an example of the estimated values estimated in the first information processing apparatus.

As illustrated in FIG. 4, the estimation unit 100 is configured to output a second element yₜ corresponding to a first element xₜ inputted at a time t. For example, when a first element x₁ is inputted at a time t₁, the estimation unit 100 outputs a second element y₁. Similarly, when a first element x₂ is inputted at a time t₂, the estimation unit 100 outputs a second element y₂.

The second element yₜ described above is outputted from each of the plurality of classification units 101 as a value corresponding to each digit of a binary code. In the example illustrated in the figure, the second element y₁ corresponding to the time t₁ is outputted as “1, 1, 0, 0”. The second element y₂ corresponding to the time t₂ is outputted as “1, 1, 1, 0”. Such a four-digit binary code may be estimated by using four classification units 101 (i.e., classification units 101 corresponding to respective digits).

### Classification by Likelihood Ratio

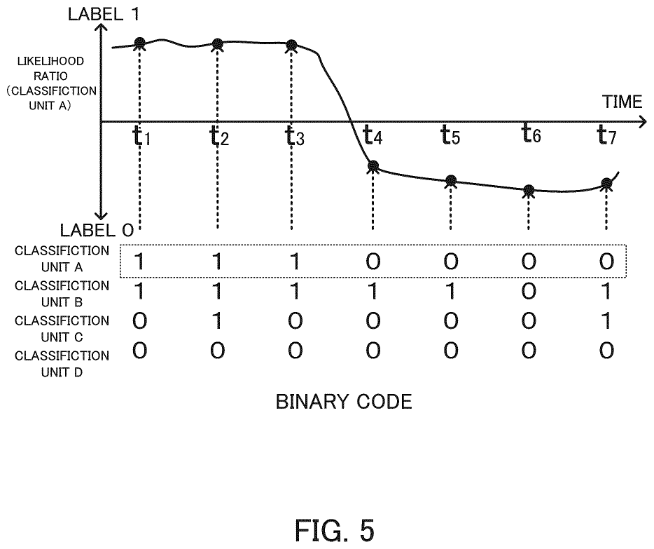

Next, with reference to FIG. 5, a classification operation by the classification unit 101 will be described in detail. FIG. 5 is a graph illustrating a method of classifying the estimated values in the first information processing apparatus.

As illustrated in FIG. 5, each digit of the binary code is estimated by the corresponding classification unit 101. Specifically, the value of each digit of the encoded second element is estimated based on the likelihood ratio calculated by the plurality of classification units 101. In an example of a classification unit A illustrated in the figure, the likelihood ratio is calculated as a value on a side of label 1 between times t₁ to t₃. Therefore, the value of the binary code corresponding to the times t₁ to t₃ is estimated as “1”. Conversely, between times t₄ to t₇, the likelihood ratio is calculated as a value on a side of label 0. Therefore, the value of the binary code corresponding to the times t₄ to t₇ is estimated as “0”. Similarly, values based on the likelihood ratio are estimated in other classification units B to D. Based on those estimation results, a 4-digit binary code is estimated at each time point.

As described above, when the first element xₜ is inputted to each of the plurality of classification units 101, the quantized and encoded second element is outputted. Therefore, the use of the pair of the first element xₜ and the quantized and encoded second element allows each of the plurality of classification units 101 to learn.

### Flow of Operation

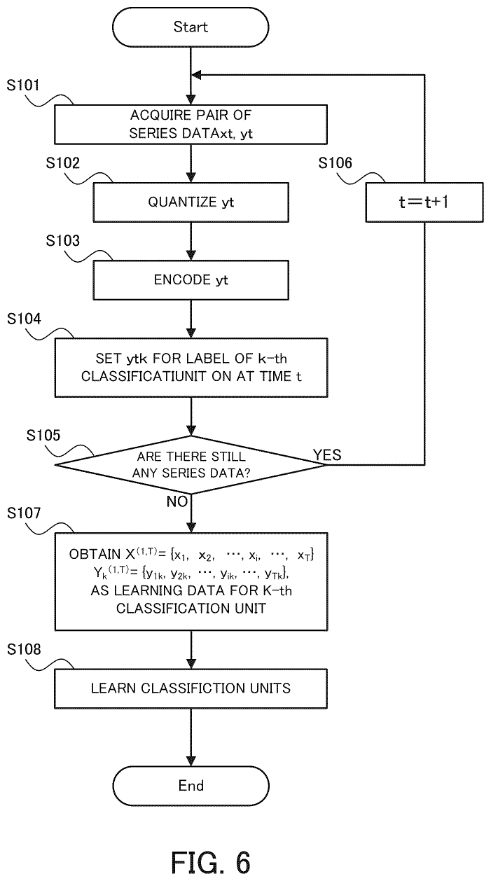

Next, with reference to FIG. 6, a flow of operation of the first information processing apparatus 10 will be described. FIG. 6 is a flowchart illustrating the flow of the operation of the first information processing apparatus.

As illustrated in FIG. 6, when the operation of the information processing apparatus 10 is started, first, the acquisition unit 50 acquires a pair of first series data X and second series data Y (step S101). The first series data X include a plurality of first elements xₜ. The second series data Y include a plurality of second elements yₜ. The first series data X and the second series data Y may not be acquired all at once, and may be acquired sequentially in series order. For example, the first series data X and the second series data Y may be sequentially acquired in element units included therein. Here, if the time at which each element is acquired is t={1, 2, . . . i, . . . , T}, then, the first series data X is X^{(1,T)}={x₁, x₂, . . . , xᵢ, . . . , x_{T}}, and the second series data Y is Y^{(1,T)}={y₁, y₂, . . . , yᵢ, . . . , y_{T}}.

Then, the quantization unit 60 quantizes the second element yₜ included in the second series data acquired by the acquisition unit 50 (step S102). Subsequently, the encoding unit 70 encodes the second element yₜ quantized by the quantization unit 60 (step S103). The encoded second element yₜ is yₜₖ={yₜ₁, yₜ₂, . . . , y_{tK}}.

Then, the learning unit 300 sets a second element yₜₖ (i.e., a k-th digit of the encoded second element yₜ) for a label of a k-th classification unit 101 at the time t (step S104). In other words, it assigns the value of each digit of the encoded second element yₜ to each of the plurality of classification units 101.

Then, the information processing apparatus 10 determines whether or not there are still unacquired series data (i.e., a pair of the first series data X and the second series data Y) (step S105). In a case where there are still unacquired series data (step S105: YES), the time is set as t=t+1 (step S106), and the processing is repeated from the step S101. That is, the processing of acquiring the first element xₜ and the second element yₜ, and quantizing and encoding the second element yₜ, is repeated until all the series data are acquired.

On the other hand, in a case where there are no unacquired series data (step S105: NO), the learning unit 300 obtains X^{(1,T)}={x₁, x₂, . . . xᵢ, . . . , x_{T}} and Y^{(1,T)}={y₁ₖ, y₂ₖ, . . . , yᵢₖ, . . . , y_{Tk}}, as learning data for the k-th classification unit 101 (step S107). Then, the learning unit 300 causes learning by each of the plurality of classification units 101, by using these learning data (step S108).

### Technical Effect

Next, a technical effect obtained by the first information processing apparatus 10 will be described.

As described in FIG. 1 to FIG. 6, in the first information processing apparatus, among the first series data X and the second series data Y acquired as the learning data, the second series data Y corresponding to the correct answer data are quantized and encoded before being used for learning. In this way, it is possible to cause the estimation unit 100 (specifically, the plurality of classification units 101) that estimates real values to learn appropriately.

It has been found that a method of regressing quantized and encoded values by classification, as in the present example embodiment, is more accurate/precise than a simple regression method (e.g., a regression method using squared error, etc.). One of the factors is that, depending on a binary encoding scheme, the error correction capability allows mistakes made by some classification units to be corrected. Furthermore, as described in the present example embodiment, regression accuracy is further improved by taking into account at least two consecutive pieces of data to calculate the likelihood ratio.

### Second Example Embodiment

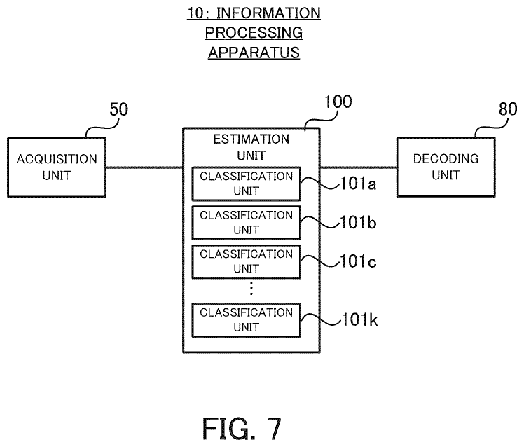

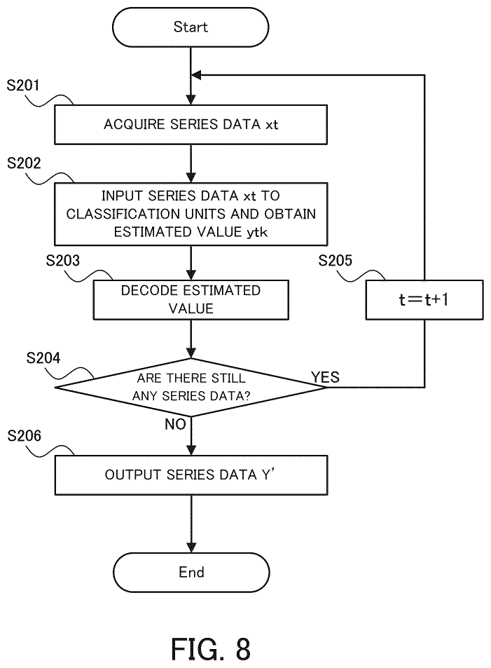

A second example embodiment will be described with reference to FIG. 7 and FIG. 8. The second example embodiment partially differs from the first example embodiment described above only in configuration and operation, and may be the same as the first example embodiment in the other parts. For this reason, a part differing from the first example embodiment will be described in detail below, and a description of the other overlapping parts will be omitted as appropriate.

### Functional Configuration

First, with reference to FIG. 7, a functional configuration of a second information processing apparatus 10 will be described. FIG. 7 is a block diagram illustrating the functional configuration of the second information processing apparatus. In FIG. 7, the same components as those illustrated in FIG. 2 carry the same reference numerals.

In FIG. 7, the second information processing apparatus 10 is an apparatus for performing estimation using the estimation unit 100 that learns in the first information processing apparatus (see FIG. 2) (i.e., estimating the second series data from the first series data). The second information processing apparatus 10 includes, as components to realize its functions, the acquisition unit 50, a decoding unit 80, and the estimation unit 100. That is, the second information processing apparatus 10 includes the decoding unit 80 that is not included in the configuration described in the first example embodiment (see FIG. 2), but does not include the quantization unit 60, the encoding unit 70, and the learning unit 300 that are used for learning. The decoding unit 80 may be a processing block realized, for example, by the processor 11 described above (see FIG. 1).

The decoding unit 80 is configured to decode the second element yₜₖ outputted from the estimation unit 100. That is, the decoding unit 80 performs processing of converting the decoded second element yₜₖ into the second element yₜ that is a real value. The decoding processing performed by the decoding unit 80 may be decoding processing corresponding to the encoding processing performed by the encoding unit 80 (see FIG. 2) described in the first example embodiment.

The acquisition unit 50 in the second processing apparatus 10 may be configured to acquire only the first series data. That is, since it is assumed that a learning operation of the estimation unit 100 described in the first example embodiment is already completed, it is not necessary to acquire a pair of the first series data and the second series data, which are the learning data, as in the acquisition unit in the first processing apparatus 10 (see FIG. 2). However, learning may be performed again while the apparatus is operated. In this case, the second information processing apparatus 10 may be configured to include the quantization unit 60, the encoding unit 70, and the learning unit 300, as in the first information processing apparatus 10.

### Flow of Operation

Next, with reference to FIG. 8, a flow of operation of the second information processing apparatus 10 will be described. FIG. 8 is a flowchart illustrating the flow of the operation of the second information processing apparatus.

As illustrated in FIG. 8, when the operation of the second information processing apparatus 10 is started, first, the acquisition unit 50 acquires the first series data X (step S201). The first series data X include a plurality of first elements xₜ. The first series data X may not be acquired all at once, and may be acquired sequentially in series order. For example, the first series data X may be sequentially acquired in element units included therein. Here, if the time at which each element is acquired is t={1, 2, . . . , i, . . . , T}, then, the first series data X is X^{(1,T)}={x₁, x₂, . . . , xᵢ, . . . , x_{T}}.

Then, the first element xₜ included in the first series data X acquired by the acquisition unit is inputted to the estimation unit 100. By this, the second element yₜₖ is obtained from the plurality of classification units 101 provided in the estimation unit 100 (step S202). The second element yₜₖ at this stage is in an encoded state (e.g., binary code). Subsequently, the decoding unit 80 decodes the second element yₜₖ (step S203). By this, the second element yₜ that is a real value, is obtained.

Then, the information processing apparatus 10 determines whether or not there are still unacquired first series data X (i.e., unacquired first element xₜ) (step S204). In a case where there are still unacquired first series data X (step S204: YES), the time is set as t=t+1 (step S205), and the processing is repeated from the step S201. That is, the processing of estimating the second element yₜₖ from the first element xₜ, decrypting it, and obtaining the second element yₜ, is repeated until all the first series data are acquired.

On the other hand, in a case where there are no unacquired first series data X (step S204: NO), the information processing apparatus outputs second series data Y′ that is an estimation result (step S206). The second series data Y′ is Y′={y′₁, y′₂, . . . , y′_{T}}.

### Technical Effect

Next, a technical effect obtained by the second information processing apparatus 10 will be described.

As described in FIG. 7 and FIG. 8, in the second information processing apparatus 10, each of digits of the second element yₜₖ encoded by using the plurality of classification units 101 is estimated and decoded, thereby obtaining the second series data Y′ that are real values. In this way, it is possible to appropriately estimate the second series data Y′ that are real values, from the first series data X. In other words, it is possible to solve a regression problem with high accuracy by using the classification units 101.

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to a user terminal. The program may be provided to a user in a form of Saas (Software as a Service), for example.

### Supplementary Notes

The example embodiments described above may be further described as, but not limited to, the following Supplementary Notes below.

### Supplementary Note 1

An information processing apparatus according to Supplementary Note 1 is an information processing apparatus including: an estimation unit that estimates second series data corresponding to first series data by inputting the first series data; an acquisition unit that acquires a pair of the first series data and the second series data; a quantization unit that quantizes a second element included in the second series data; an encoding unit that encodes the quantized second element; and a learning unit that assigns a value of each digit of the encoded second element to respective one of a plurality of classification units provided in the estimation unit, and that causes leaning by each of the plurality of classification units by using a first element included in the first series data and the assigned second element.

### Supplementary Note 2

An information processing apparatus according to Supplementary Note 2 is the information processing apparatus according to Supplementary Note 1, wherein the plurality of classification units learn as a model for calculating a likelihood ratio regarding the value of each digit of the encoded second element, by inputting the first elements that are adjacent to each other.

### Supplementary Note 3

An information processing apparatus according to Supplementary Note 3 is an information processing apparatus including: a data acquisition unit that acquires first series data; a plurality of classification units that estimate, by inputting a plurality of first elements included in the first series data, values of each digit of encoded second elements corresponding to the first elements; and a decoding unit that decodes the values of each digit of the second elements estimated by respective one of the plurality of classification units, thereby obtaining second series data corresponding to the first series data.

### Supplementary Note 4

An information processing method according to Supplementary Note 4 is an information processing method that causes leaning by an estimation unit that estimates second series data corresponding to first series data by inputting the first series data, the information processing method including: acquiring a pair of the first series data and the second series data; quantizing a second element included in the second series data; encoding the quantized second element; and assigning a value of each digit of the encoded second element to respective one of a plurality of classification units provided in the estimation unit, and causing leaning by each of the plurality of classification units by using a first element included in the first series data and the assigned second element.

### Supplementary Note 5

An information processing method according to Supplementary Note 5 is an information processing method including: acquiring first series data; estimating, by inputting a plurality of first elements included in the first series data, values of each digit of encoded second elements corresponding to the first elements; and decoding the values of each digit of the second elements estimated, thereby obtaining second series data corresponding to the first series data.

### Supplementary Note 6

A recording medium according to Supplementary Note 6 is a recording medium on which a computer program that allows a computer to execute an information processing method is recorded, the information processing method causing leaning by an estimation unit that estimates second series data corresponding to first series data by inputting the first series data, the information processing method including: acquiring a pair of the first series data and the second series data; quantizing a second element included in the second series data; encoding the quantized second element; and assigning a value of each digit of the encoded second element to respective one of a plurality of classification units provided in the estimation unit, and causing leaning by each of the plurality of classification units by using a first element included in the first series data and the assigned second element.

### Supplementary Note 7

A recording medium according to Supplementary Note 7 is a recording medium on which a computer program that allows a computer to execute an information processing method is recorded, the information processing method including: acquiring first series data; estimating, by inputting a plurality of first elements included in the first series data, values of each digit of encoded second elements corresponding to the first elements; and decoding the values of each digit of the second elements estimated, thereby obtaining second series data corresponding to the first series data.

### Supplementary Note 8

A computer program according to Supplementary Note 8 is a computer program that allows a computer to execute an information processing method, the information processing method causing leaning by an estimation unit that estimates second series data corresponding to first series data by inputting the first series data, the information processing method including: acquiring a pair of the first series data and the second series data; quantizing a second element included in the second series data; encoding the quantized second element; and assigning a value of each digit of the encoded second element to respective one of a plurality of classification units provided in the estimation unit, and causing leaning by each of the plurality of classification units by using a first element included in the first series data and the assigned second element.

### Supplementary Note 9

A computer program according to Supplementary Note 9 is a computer program that allows a computer to execute an information processing method, the information processing method including: acquiring first series data; estimating, by inputting a plurality of first elements included in the first series data, values of each digit of encoded second elements corresponding to the first elements; and decoding the values of each digit of the second elements estimated, thereby obtaining second series data corresponding to the first series data.

The present disclosure is allowed to be changed, if desired, without departing from the essence or spirit of this disclosure which can be read from the claims and the entire specification. An information processing apparatus, an information processing method, and a recording medium with such changes are also intended to be within the technical scope of the present disclosure.

### DESCRIPTION OF REFERENCE CODES

10 Information processing apparatus
11 Processor
50 Acquisition unit
60 Quantization unit
70 Encoding unit
80 Decoding unit
100 Estimation unit
300 Learning unit

What is claimed is:

1. An information processing apparatus comprising:
at least one memory that is configured to store instructions; and
at least one processor that is configured to execute the instructions to:
estimate second series data corresponding to first series data by inputting the first series data;
acquire a pair of the first series data and the second series data;
quantize a second element included in the second series data;
encode the quantized second element; and
assign a value of each digit of the encoded second element to respective one of a plurality of classification units, and cause learning by each of the plurality of classification units by using a first element included in the first series data and the assigned second element.

2. The information processing learning apparatus according to claim 1, wherein the plurality of classification units learn as a model for calculating a likelihood ratio regarding the value of each digit of the encoded second element, by inputting the first elements that are adjacent to each other.

3. An information processing apparatus comprising:
at least one memory that is configured to store instructions; and
at least one processor that is configured to execute the instructions to:
acquire first series data;
estimate, by inputting a plurality of first elements included in the first series data, values of each digit of encoded second elements corresponding to the first elements; and
decode the values of each digit of the second elements estimated, thereby obtaining second series data corresponding to the first series data.

4. An information processing method that causes learning by an estimation unit that estimates second series data corresponding to first series data by inputting the first series data, the information processing method comprising:
acquiring a pair of the first series data and the second series data;
quantizing a second element included in the second series data;
encoding the quantized second element; and
assigning a value of each digit of the encoded second element to respective one of a plurality of classification units provided in the estimation unit, and causing learning by each of the plurality of classification units by using a first element included in the first series data and the assigned second element.

5.-7. (canceled)
